(19) United States
(12) Patent Application Publication
(10) Pub. No.: US 2008/0275722 A1
(43) Pub. Date: Nov. 6, 2008

(54) Method To Identify And Prioritize Modifiable Risk Factors Resulting In Interventions That Focus On Individuals

(75) Inventor: Robert Derek Newell, Emeryville, CA (US)

Correspondence Address: MORRISON & FOERSTER LLP, 12531 HIGH BLUFF DRIVE, SUITE 100, SAN DIEGO, CA, 92130-2040, US

(73) Assignee: LifeMaster Supported SelfCare, Inc., Irvine, CA (US)

(21) Appl. No.: 11/576,943

(22) PCT Filed: Oct. 13, 2005
(86) PCT No.: PCT/US05/36783

§ 371 Date: May 2, 2008

Related U.S. Application Data
(60) Provisional application No. 60/618,551, filed on Oct. 13, 2004.

(51) Int. Cl. G06Q 50/00

(52) U.S. Cl. 705/2

(57) ABSTRACT

The disclosed invention relates to a method of delivering individually customized, evidence-based intervention plans that focus on the specific needs of each participant across an entire population. Through the identification of each program participant's modifiable risk-factors and cost drivers, indicated by deviations from the most up-to-date best practices and nationally-based guidelines of care, the described system maximizes outcomes for each member in the most cost-effective manner possible, leading to increased return on investment (ROI), improved outcomes and greater participant satisfaction.

### TECHNICAL FIELD

The disclosed invention relates to a method of delivering individually customized, evidence-based intervention plans that focus on the specific needs of each participant across an entire population. Through the identification of each program participant's modifiable risk-factors and cost drivers, indicated by deviations from the most up-to-date best practices and nationally-based guidelines of care, the described system maximizes outcomes for each member in the most cost-effective manner possible, leading to increased return on investment (ROI), improved outcomes and greater participant satisfaction.

### BACKGROUND ART

Standard healthcare practices in use today have gaps that reduce healthcare quality. These gaps have been identified in several recent studies and publications that have documented that a high percentage of people with chronic conditions are not receiving evidence-based care. For example, a recent article in the New England Journal of Medicine reported that more than 75% of people with diabetes had not received an HbA1C test. This test measures average blood glucose levels over a two to three month period. The test provides a broader frame of reference than the daily measurements taken by the patient. Accordingly and it is fundamental to the effective management of patients with diabetes. In another study on disease management conducted by Patrick Marketing, 42% of healthcare executives responding believe that their participating physicians do not practice evidence-based medicine. Ninety one percent of them felt that improved disease management techniques could help address this issue.

The gaps in standard healthcare practices are not caused a lack of medical information or the will to provide the right care at the right time. What is lacking is a system that quickly and accurately identifies those caregivers who are not in adherence with the current guidelines and addresses those gaps in a cost-effective, scalable manner.

### BRIEF DESCRIPTION OF THE DRAWINGS

FIG. 1 shows a flow chart of the disclosed system of patient management.

### SUMMARY OF THE INVENTION

The disclosed invention relates to a system for the cost-effective and scalable delivery of disease management services. The described system creates a comprehensive participant profile by integrating all available data (including demographic, medical claims, pharmacy, lab results, biometric data, health risk assessments and psychological issues) to stratify program participants dynamically and create customized action plans that change as the participant's health status changes. The ability to customize these capabilities enables one to direct the proper level of resources to the appropriate program participant at the correct moment in time, thus producing greater efficiency, lower program costs and a higher return on investment for users of the system. In addition, the present system uses predictive modeling better determine which individuals and groups in a population are most likely to develop health problems, and at what cost to the payers of healthcare programs.

### MODES OF CARRYING OUT THE INVENTION

The disclosed invention relates to a system of monitoring healthcare protocols and patient response information and optimizing them to maximize patient progress while minimizing cost. The system identifies the most current and relevant disease state indicators and creates treatment protocols to maximize cost-effective healthcare measures. The disclosed system incorporates identified variables into a dynamic predictive model, building the data collection and integration engine to incorporate behavioral as well as clinical and financial factors, and developing the appropriate interventions. The disclosed system provides a platform that allows healthcare providers to focus efforts on those lifestyle and behavioral issues and gaps in the standard of care that will deliver the highest return on investment.

The disclosed system is superior to systems presently in use because, rather than just focusing on an individual's chronic condition, the system integrates his or her claims, administrative, clinical, and self-reported data and regularly assesses all of his or her healthcare and psychosocial needs. Next, the system creates customized interventions that are continuously updated and patient-focused, not static and disease-based like traditional disease management. The described system proactively and dynamically—in real-time—identifies each individual's modifiable risk factors and cost drivers, using deviations from the most up-to-date research-based best practices and nationally recognized standards of care. By customizing the program to fit the special needs of each participant, the disclosed system allows one to identify members at the early stages of chronic illness and intervene before intensive treatment becomes necessary. The present system also ensures interventions are targeted to the right individuals at the right time for the right reasons, making the interactions much more efficient and cost-effective, yet relevant and satisfying for both the patient and the healthcare provider.

The present system allows one to provide physicians with relevant data for early intervention. This service reduces preventable exacerbations through participant monitoring, frequent, even daily data collection, analysis against individual thresholds, and exception and trend reports. Payors realize reduced costs through fewer unnecessary office visits and emergency admissions.

The described system evaluates each individual against important criteria such as psychosocial risk factors, clinical indicators, modifiable risk behaviors and utilization on an ongoing basis to develop the most appropriate intervention that shifts dynamically as his/her needs change. A subject status is automatically generated for each individual, which creates an up to date summary of his/her status based on the continuous reassessment of the system's criteria. This translates to an action plan, which is a customized plan prioritizing the actions healthcare providers need to take based on the severity and importance of each risk factor and deviation from best practices and nationally recognized standards of care. Coaching, education, and support are more targeted making patient-healthcare provider interactions more efficient yet more personalized and satisfying. When necessary, an exception report is provided to the participant's personal physician enabling him/her to proactively modify the treatment plan and avoid exacerbations. These innovative tools help healthcare professionals to provide the best intervention possible to ensure the best possible outcomes.

The System

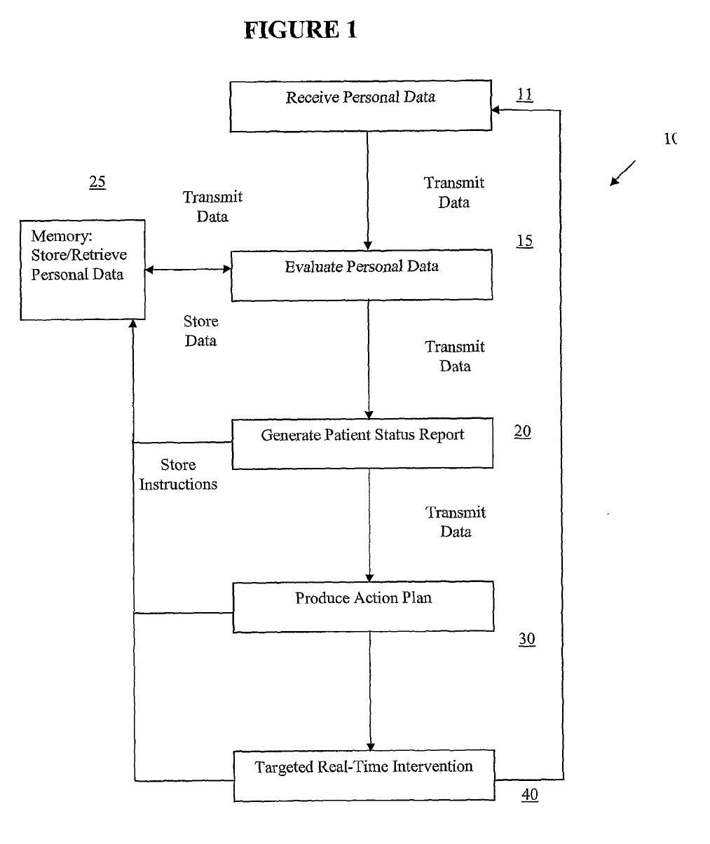

The disclosed system uses table-driven rules and a point system to evaluate the indicators for a participant. The rules specify normal and abnormal values for each indicator so that the system can compare participant values to desired ones. The point system captures both the “out of bound-ness” of the participant value on each indicator and can provide relative scores across indicators to facilitate identification of the most critical indicators for each person. Several different types of scoring can be performed. Each type of scoring will be used for different purposes. FIG. 1 shows a flow chart of the system 10.

Personal data is received into the system (11), which is then transmitted for evaluation. The personal data is then evaluated (15) to establish a Health History (HH) of the patient. The HH is stored for future use. The generated HH is analyzed to establish scores for the patient concerning various health-related criteria. The product of this analysis is used to generate a treatment program (20). The generated treatment program is transmitted for further analysis and the production of a personalized action plan (30). The action plan is then transmitted to various recipients for implementation (40). Data is continuously gathered from the patient so that the effects of the implementation of the Action Plan can be accessed. New data points gathered following treatment allow the program to generate new treatment programs which implement the data regarding the treatment results.

Personal Data Acquisition

Data from patients enrolled in the program is gathered and formulated for input to the system. A preferred method for data acquisition is via telephone. In this aspect of the system, a call center is provided where program healthcare professionals (LHPs) interact with patients (participants) and clients (e.g., a health plan, hospitals, employer, governmental organization, insurance company and the like which contracts with the program for the service). While telephonic data gathering is a preferred embodiment, other means of data collection are also contemplated. For example, automated monitoring of patients for data collection is an alternative method of data collection. In this aspect of the invention, a biometric device which reads vital signs (VS) such as blood pressure, pulse rate, blood glucose levels, blood gases, BUN and other biomarkers and transmits the gathered data to the call center.

In a preferred embodiment a Call Center is utilized to gather personal data from patients and transmit program products to physicians and other healthcare service providers. The term “Call Centers” are the physical entities where LHPs interact with participants and clients. The centers consist of three key areas: enrollment, clinical, and fulfillment. They also perform other support applications, such as physician relations. The term “healthcare provider” (HCP) refers to a provider of health care professional not associated with an institution. Designations for such health care providers include Advanced Registered Nurse Practitioner (ARNP), Certified Pediatric Nurse Practitioner (CPNP), Doctor of Chiropractic Medicine (DC), Doctor of Dental Science or Doctor of Dental Surgery (DDS), Doctor Osteopathic Medicine (DO), Doctor Podiatric Medicine (DPM), Family Nurse Practitioner (FNP), Medical Doctor (MD), Naturopathic Doctor (ND), Nurse Practitioner (NP), Physician's Assistant (PA), and Physician's Assistant Certified (PAC).

Additionally, the term call-flow relates to a process followed by Call Center staff when making calls to participants. It includes the sequence and content of a call. The term refers to the actual steps in conducting a call such as an alert call and is documented as a call-flow use case. The term “Alert Call” refers to a call generated when a participant reports symptoms or vital signs outside normal parameters. When such a situation is detected, a staff member contacts the participant, which may lead to an exception report.

The term workflow relates to a defined process the Call Center staff uses when interacting with participants. In contrast to call-flow, workflow is more general and encompasses one or more calls, such as the workflow for the engagement process, which consists of a Welcome call, an Engagement call, etc.

Personal data is gathered at regular intervals from patients involved with the system. The determination of the frequency at which inquiries of the patient are made is based on the severity of the patient's medical condition. The term “Monitoring, Heavy” refers to a participant with monitoring frequency of more than 11 times in the last 30 days. The term “Monitoring, Low” refers to a participant with monitoring frequency between 2 and 4 times in the last 30 days. The term “Monitoring, Moderate” refers to a participant with monitoring frequency between 5 and 11 times in the last 30 days. The term “Monitoring, No” refers to a participant with monitoring frequency of less than 2 times in the last 30 days (that is, Never or Once). The term “On-hold” refers to participants can be placed “on-hold” for a variety of reasons including: vacations, being out of the country, and not ready to participate in the program.

The term “Monitoring and Reporting” refers to a process whereby a participant reports vital signs and symptoms through one of the following tools or methods: IVR (phone), over the web, through an automated monitoring device, or through an LHP.

Health History

Once a participant is enrolled into the system, an initial health history (HH) is generated. The HH is a program data collection tool for participant self-reported current or historical health information. HH is not an assessment; it is used to identify the health condition of the participant and directs the program intervention. HH is required for participants that are at any risk level.

The HH is compiled using a set of questions relating to particular disease states. The questions that display within the Health History are based upon the answers that the participant gives to the disease-state questions. Previously, all questions displayed for all participants. Now, only the questions that are linked to specific disease-states that the participant states he/she has a history of will appear. Please see “Appendix A: Display of Questions by Disease State” for more details on which questions display and under what circumstances. An additional set of questions is provided at Appendix B.

In addition to patient health information, the Health History can also contain data regarding claims filed by the patient.

Indicators Generally

The term indicator relates to a factor which is measurable based on current national standards for quality and best practice. Examples of indicators include clinical indicators (CIs), risking (RI), education (E), and root cause (RC).

The importance of indicators varies when considering their impact on the patient's health state. The system accommodates this variability by weighting the assigned score to the indicator. Each indicator also has a range of values that indicates the severity of the indicator and each value or range of values has a total score (point value) associated with it. An indicator's values are grouped into the following severity categories:

missing (indicates required data is not available to determine severity),

at goal,

at risk,

above target,

outlier, and

critical outlier.

The weighting and the point value provide a Total Score for an indictor at any particular level.

Total Score=(Indicator Importance)×(Indicator Severity)

This score reflects the indicator's importance to the participant's health condition, which will be displayed in computerized patient record (CPR) as either within-normal-limits (if point value is at goal) or out-of-range (if point value is either at risk, above target, outlier, or critical outlier). In addition, missing indicator information is assigned a point score in order to highlight what data must be collected in managing a particular disease.

Clinical Indicators

Clinical Indicators (CIs) are an important component of the system operating infrastructure and are primarily derived from the clinical literature. They include laboratory values, utilization parameters, clinical symptoms, practice guidelines, psychosocial factors, and self-care practices that are associated with an individual patient.

The term “Out-of-Range (Clinical Indicators)” refers to Clinical indicators that are not “at goal” are displayed in the CPR's Indicator Summary as “Out-of-Range” and in the script navigation pane (Indicators tab) of the CPR. The criterion used to determine out-of-range indicators is based on standard clinical guidelines for disease states supported by the program.

Risking Indicators

The term risking (RI) relates to elements of the patient assessment process used to assess increased risk of morbidity and/or mortality.

Education

The term education (E) relates to participant required knowledge that serves to decrease root causes and risking elements, and improve compliance with indicators to achieve positive outcomes.

Root Cause

The term root cause (RC) relates to a basic element that contributes to an indicator being outside of established parameters. For example, a root cause could have several variables, such as self and/or physician behavior practices or knowledge deficits.

Non-Clinical Indicators

The term non-clinical indicator relates to issues (such as travel, medication, family, and financial concerns) which may impede data collection, adversely affect the participant's health or behavior.

Patient Status Report (PSR)

The PSR provides a view of a patient's data for use by the program's clinical. The data in the PSR is derived from the HH, claims, lab results, and self-reported data. The PSR provides a summary of a participant's indicator information and Total Score analysis. Indicators are prioritized from highest need of attention to the lowest. Priority is based upon a combination of the importance of the indicator to the patient's outcome and the amount (based on a score) the patient's value are out-of-range from a normal limit.

The PSR typically lists indicators and a value summary for the indicators queried. Relevant indicators will typically be noted with a conclusory flag indicating the state of that particular indicator. Exemplary flags include “Out of Range”; “Missing” and “WNL”—abbreviation for Within Normal Limits.

Indicators are displayed according to whether or not a value exists in the record and what that value is in relationship to the normal range. The indicators are also typically displayed from highest importance to lowest importance. Indicators that have been deferred are marked, typically with the date of last assessment and reason for the deferral.

Action Plan

The PSR is used by the program's clinical staff (LHP) to prepare an Action Plan specific for the patient. For this purpose the LHPs rely upon the Action Plan Library to prepare the Action Plan. The term “Action Plan Library” refers to a library consisting of a list of appropriate actions to support LHP and participants in reaching micro-goals and improving outcomes. For example, the library contains plan-driven scripts and fulfillment items in planning for the care of the participant.

The LHPs will select appropriate scripts and educational items which are then provided to the patient for their use. The Action Plan reflects the program's understanding of best the most up-to-date research-based best practices and nationally recognized standards of care. In a preferred embodiment the patient's physician or other healthcare provider receives a copy of the Action Plan for modification in view of that professional's judgment.

Real-Time Intervention

Once the Action Plan is formulated, it is implemented by staff members of the program. Typically the patient is provided a copy of the Action Plan, for example by mail, via the internet, etc. Staff members of the program work with the patient to implement the Action Plan. This interaction increases patient compliance with their healthcare provider's treatment regiment.

As illustrated in FIG. 1, following the intervention stage of the system, the program repeats and predetermined intervals. This cyclical approach allows for the acquisition of continuously updated information. This feature permits Action Plans and interventions to be formulated proactively and dynamically, in real-time.

Exception Report

In certain cases the data acquisition and evaluation stages of the program may identify potentially health threatening situations occurring in the patient. Under these circumstances, an exception report is generated and transmitted to the patient's physician or healthcare professional. The term “Exception Report (ER) process” refers to a participant's out-of-range vital signs, symptoms, or request to speak with a nurse generates an alert on the PSR. The CNC reviews the alert and calls the participant. If deemed clinically appropriate, the CNC generates an exception report and faxes it to the participant's physician. Follow-up calls are placed to all participants who were sent an ER.

### APPENDIX B

### Changes to Health History Questions

| Question | Response | |
|---|---|---|
| In the past 12 months, have you been | Yes | |
| hospitalized for any symptoms related to HF, | No | |
| DM, CAD, HTN, Asthma, COPD? | I don't know | |
| Date of last (hospital) visit (mm/dd/yyyy) | mm/dd/yyyy | |
| In the past 12 months have you been to the | Yes | |
| emergency room for any for any symptoms | No | |
| related to HF, DM, CAD, HTN, Asthma, | I don't know | |
| COPD? | | |
| Date of last ER visit | mm/dd/yyyy | |
| In the past 12 months have you been to your | Yes | |
| doctor's office for any reason? | No | |
| | I don't know | |
| Date of most recent MD office visit | mm/dd/yyyy | |
| In the past year, did you take oral steroids for a | Yes | |
| short while to help control an acute episode? | No | |
| | I don't know | |
| Date of usage | mm/dd/yyyy | |
| In the past year, do you know how many | Yes | |
| canisters of your quick relief inhalers you have | No | |
| used. | I don't know | |
| Number of canisters in a year | nn | |
| In a month's time, how many canisters of your | Yes | |
| quick relief inhaler do you use? | No | |
| | I don't know | |
| Number of canisters in a month | nn | |
| In the past month, do you know how many | Yes | |
| days in a week you used your quick relief | No | |
| inhaler? | I don't know | |
| In the past week, how many days did you use | nn | |
| your quick relief or rescue inhaler? This | | |
| excludes using it before you exercise. | | |
| Have you ever had a test called a spirometry? | Yes | |
| A breathing test you have in your doctor's | No | |
| office or lab where you blow into a machine. | I don't know | |
| Date of spirometry test | Mm/dd/yy | |
| Do you know the most recent spirometry | Yes | |
| value? | No | |
| | I don't know | |
| Spirometry test value | nn | |
| Are you exposed to 2nd hand smoke in the | Yes | |
| home? | No | |
| How many cigarettes do you smoke in a day? | nn | |
| How many years have you smoked? | nn | |
| Are you participating in a smoking cessation | Yes | |
| program or using smoking cessation aids like | No | |
| nicotine gum, inhaler or bupropion? | | |
| Have you smoked in the past? | Yes | |
| | No | |
| How many cigarettes did you smoke in a day? | nn | |
| For how many years did you smoke? | Nn (up to 20) | |
| Do you know the most recent value of your | −2 | Yes |
| HbA1c test? | −3 | No |
| | −16 | I don't know |
| Do you know the most recent value of your | −2 | Yes |
| microalbumin test? | −3 | No |
| | −16 | I don't know |
| Do you know the most recent value of your | −2 | Yes |
| serum creatine test? | −3 | No |
| | −16 | I don't know |
| Do you know the most recent value of your | −2 | Yes |
| total cholesterol test? | −3 | No |
| | −16 | I don't know |
| Do you know the most recent value of your | −2 | Yes |
| LDL cholesterol test? | −3 | No |
| | −16 | I don't know |
| Do you know the most recent value of your | −2 | Yes |
| HDL test? | −3 | No |
| | −16 | I don't know |
| Do you know the most recent result of your | −2 | Yes |
| triglycerides test? | −3 | No |
| | −16 | I don't know |
| Do you know the most recent result of your | −2 | Yes |
| Ejection Fraction Test | −3 | No |
| | −16 | I don't know |
| Date you stopped smoking | Dd/mm/yyyy | |
| Latest Spirometry Test Value | nn | |
| In the past year, have you had a blood test for | −2 | Yes |
| Cholesterol? It measures the amount of fat in | −3 | No |
| your blood. | −16 | I don't know |
| In the past year, have you had a blood test for | −2 | Yes |
| HDL Cholesterol? It measures the amount of | −3 | No |
| good fat in your blood, | −16 | I don't know |
| In the past year, have you had a blood test for | −2 | Yes |
| LDL cholesterol? | −3 | No |
| | −16 | I don't know |
| In the past year have you had a blood test | −2 | Yes |
| forTriglycerides? It measures another fat in | −3 | No |
| your blood. | −16 | I don't know |
| Do you know your usual blood pressure | −2 | Yes |
| | −3 | No |

Obsoleted Questions

### APPENDIX C

### Rules for Navigation Pane Script Display and Documentation

| | | Summary | Grid | |
|---|---|---|---|---|
| Checkbox | Questions | Display | Documentation | Harvey Ball |
| Unchecked | None Checked | Does not | Does not | Unfilled |
| | | Display | Document | |
| Checked | None Checked | Does not | Does not | Unfilled |
| | | Display | Document | |
| Unchecked | Some Checked; | Displays | Documents | Half Filled |
| | Or All Checked | | | |
| Checked | Some Checked; | Displays | Documents | Filled |
| | Or All Checked | | | |

### APPENDIX D

### Differences in Engagement Pane by Intervention Level

The difference between the low intervention participant and the high/mod intervention participants are:
The Monitoring script is not present.
The 5^{th} work item is a pre-filled checkbox with the participant identified as low intervention rather than the “Assess readiness for monitoring” checkbox.

The rules for a completed engagement are scripts “Program Introduction” and “Preventive Care” completed. All 5 work items checked off.

The Rules layer defines the indicator ranges and determines whether a particular value for an indicator will fall into one of the defined buckets. Each row in the rules layer is subject to “element usage.” That is, there may actually be multiple rules defined for each indicator, but only one will apply to an individual. The usual element usage conditions are to determine which rule applies to an individual. Element usage can be customized on gender, age, disease state, customer, perhaps intervention level.

For example:
we can have one LDL rule for males, over age 65 with CHF (they need a test every six months) and another rule for everyone else (they need a test every year)
We can have one set of BP limits for diabetics (good level is 130/80) and another rule for everyone else (140/85).

The Rules layer provides the rules for creating the Scoring layer for an individual person's values. It should be easy to change if clinical guidelines change. It should be easy to QA so that we have no gaps in the rules and can easily verify that we can score everyone.

(For multi-variable items, like BP, the worst bucket is used. So a BP of 125/87 would fall into the Bad Value bucket, because one of the variables satisfied the Good Value range, one the Bad Value range. We take the worst one we find.) The “have date” column gives the interval for which we consider a value to be valid. For example, a 3 year old HbA1c may be useless. Even if a value is present in the database, we may ignore it if it is too old. An “aging date” means we have a value, but it is going to go invalid soon, and needs to get updated. The rules table stores the trigger time for reminders.

| | | | | | | | | | Really |
|---|---|---|---|---|---|---|---|---|---|
| | | Have | | Aging | | No | Good | Bad | Bad |
| TESTS | Usage | Date | | Date | | Value | Value | Value | Value |
| BP | Diabetics | <12 | months | >3 | months | | <130/80 | >=130/80 | >=145/95 |
| | | | | | | | | <145/95 | |
| BP | Everyone | <12 | months | >6 | months | | <140/85 | >=140/85 | >=160/90 |
| | without | | | | | | | <160/90 | |
| | diabetes | | | | | | | | |
| Flu | | <1 | year | >10 | months | N/A | N/A | N/A | N/A |
| Pneomvac | | <5 | years | >4 | years | N/A | N/A | N/A | N/A |

| LDL | | | | | |
|---|---|---|---|---|---|
| Microalb | | | | | |
| HbA1c | diabetics | | | | <7.5 |
| Eye Exam | diabetics | <1 | year | N/A | |
| Foot Exam | Diabetics | <1 | year | | |

| Ejection | CHF | | | |
|---|---|---|---|---|
| Fraction | | | | |
| Spirometry | Asthma | | | |
| Smoking | | N/A | N/A | N/A |

| | | | | | | | Really |
|---|---|---|---|---|---|---|---|
| | | Have | Aging | No | Good | Bad | Bad |
| MEDS | Usage | Date | Date | Value | Value | Value | Value |
| ACE/ARB | CHF | | <6 | | On med | Not on | N/A |
| | | | months | | | | |
| Antiplatlet | CHF | | | | | | |
| Beta | CHF | | | | | | |
| Blocker | CAD | | | | | | |
| Asthma | Asthma | | | | | | |
| meds | | | | | | | |

| | | | | | | | Really |
|---|---|---|---|---|---|---|---|
| | | Have | Aging | No | Good | Bad | Bad |
| EXACERB. | Usage | Date | Date | Value | Value | Value | Value |
| Recent | | | | | <2 in 6 | >=2 in 6 | >4 in 3 |
| Hosp | | | | | months | months | months |
| | | | | | | and <4 | |
| | | | | | | in 3 | |
| | | | | | | months | |
| Recent | | | | | | | |
| ER | | | | | | | |

| | | | | | | | Really |
|---|---|---|---|---|---|---|---|
| | | Have | Aging | No | Good | Bad | Bad |
| EDUCATION | Usage | Date | Date | Value | Value | Value | Value |
| Asthma | asthma | ?? | N/A | | Have | No | N/A |
| Action | | | | | plan | plan | |

The Points layer assigns a weighted point value to the different “buckets.” It is used to calculate various scores. More than one type of score can be derived from this table, and not all points may get included in any single score. Different types of scores will be used to drive different parts of the system. The points again have element usage applied, so different point values may be assigned to different groups of people. The element usage must match the element usage in the rules layer, which defines the structure of the buckets.

A quick look at this table shows how we are weighting various factors in our program. Indicators may have different weights relative to each other, and the severity as we move from good to really bad values may be different for different indicators. (They do not need to be different, but the flexibility is there if we need it.)

The indicator importance is a multiplier for the other point value columns. It indicates the weight assigned to this indicator in the overall score. (So, for some items, like dental exam, that we collect for specific customer reasons, we may assign an indicator importance of 0 to remove the indicator from scores related to how sick the person is.)

| | | | | | | | | | Really |
|---|---|---|---|---|---|---|---|---|---|
| | | Indicator | No | Have | Aging | No | Good | Bad | Bad |
| | Usage | Importance | Info | Date | Date | Value | Value | Value | Value |
| BP | Not | 2× | 1 | 0 | | 1 | 0 | 1 | 2 |
| | diabetic | | | | | | | | |
| BP | diabetics | 2× | 1 | 0 | | 1 | 0 | 1 | 4 |
| Flu | | 1× | 1 | 0 | | 0 | | | |
| Pneumovac | | 1× | 1 | 0 | | 0 | | | |
| LDL | | 2× | 1 | 0 | | 1 | 0 | 1 | 4 |
| Microalb | | 2× | 1 | 0 | | 1 | 0 | | |
| HbA1c | | 2× | 1 | 0 | | 1 | 0 | | |
| Eye Exam | | 2× | 1 | 0 | | 0 | | | |
| Foot Exam | | 2× | 1 | 0 | | 0 | | | |
| Ejection | | 1× | 1 | 0 | | 1 | | | |
| Fraction | | | | | | | | | |
| Spirometry | | 1× | 1 | 0 | | 1 | 0 | | |
| Smoking | | | 1 | 0 | | 1 | 0 | | |
| ACE/ARB | | | 1 | 0 | | 1 | | | |
| Antiplatlet | | | 1 | 0 | | 1 | | | |
| Beta | | | 1 | 0 | | 1 | | | |
| Blocker | | | | | | | | | |
| Asthma | | | 1 | 0 | | 1 | | | |
| meds | | | | | | | | | |
| Asthma | | | 1 | 0 | | 1 | | | |
| Action | | | | | | | | | |
| Recent | | | | | | | | | |
| Hosp | | | | | | | | | |
| Recent ER | | | | | | | | | |

The Score layer is calculated for each participant, based on the current values of the indicator data. This may be a “virtual” table, and never exist in the database, but rather may be calculated on the fly as needed or it may be convenient to calculate an actual table at certain times using a background job and store it so applications and reports have it handy. The score layer rows use the Rules layer, after applying element usage, to determine which indicators apply to this person and to determine which bucket gets a 1. The indicator data we have for the person is compared to the rules, generating the table for the person. This table contains only 0s (or blanks) and 1s, which are flags showing which buckets the participant's indicator data falls into at this time. There is no element usage needed in this set of data. Rather the participant's age, gender, customer, diseases drive which rules are applied. Either this data, or the resulting scored data, may need to be saved in a snapshot in the warehouse so we can see how it changes over time.

| | | | | | | | Really |
|---|---|---|---|---|---|---|---|
| | No | Have | Aging | No | Good | Bad | Bad |
| | Info | Date | Date | Value | Value | Value | Value |
| BP | 1 | | | | | | |
| Flu | 0 | 1 | | | | | |
| Pneumovac | 1 | 0 | | 0 | 0 | | |
| LDL | 0 | 1 | 1 | 0 | 1 | | |
| Microalb | 1 | 1 | | 1 | 0 | | |
| HbA1c | 0 | 1 | | 0 | 0 | 0 | 1 |
| Eye Exam | 1 | 0 | | | | | |
| Foot Exam | 0 | 0 | | | 1 | | |
| Ejection | 1 | 0 | | | | | |
| Fraction | | | | | | | |
| Spirometry | | 0 | | 1 | 0 | | |
| Smoking | | | | 1 | 0 | | |
| ACE/ARB | 1 | 0 | | | | 1 | |
| Antiplatlet | | | | | | | |
| Beta Blocker | | | | | | | |
| Asthma meds | | | | | | | |
| Asthma | | | | | | | |
| Action | | | | | | | |
| Recent Hosp | | | | | | 1 | |
| Recent ER | | | | | 1 | | |

### Scoring and Content:

A person's “assessment needed” score is generated by summing the appropriate No Data or No Value points. A value above a certain level triggers a mailing or an assessment call of some type.

The “aging date” bucket means the person had the test, but is almost due for one again. This can be used to drive reminder postcards, etc. It shouldn't count in the total score. A person's “illness” score is generated by:
Multiply the scoring level for each bucket with the underlying point value for that bucket. For each indicator, make sure to apply element usage to get the point row that applies to this person before doing the multiplication.

Sum all the resulting bucket values to get a total “illness” score. The “illness” score for each person will rank the person against all other people (in the system or in that contract). Once they are ranked, we can determine cutoff values for each call frequency type. If 10% of the people are to receive weekly calls, then the top 10% of the people can be identified from their score. If we choose to have a “campaign” for certain indicators (like 6 month period where we concentrate on improving LDL for all customers), that indicator importance can be increased, and the affected people will bubble up to the top of the list so they can be processed more intensively. If we have both claims and self-reported data, we need rules on which to use and when. We don't want to double count an event toward exacerbations because it was reported in 2 different ways. Educational content, PSR display, problems, reminders, can be derived directly off the scoring layer. For example, if a person doesn't have an asthma action plan, certain content can be suggested when we talk to the person. The asthma action plan may not contribute at all to the “illness” score.

We claim:

1. A system for patient management comprising:
a data input port, wherein patient data is gathered,
an evaluation algorithm which receives the patient data from the data input port, wherein the evaluation algorithm analyzes the patient data is using a table-driven rules and a point system which allocates a numeric value for the patient data;
a treatment program formulation system, wherein the numeric values are compared to standards and treatment options comprising a treatment program is prepared based on the numeric values; and
an action plan generator, which receives the treatment program and formulates an action plan which is transmitted to a recipient for action.
